(19) United States
(12) Patent Application Publication
(10) Pub. No.: US 2007/0196240 A1
(43) Pub. Date: Aug. 23, 2007

(54) Multi-slot Test strip vial

(75) Inventors: Brad Boozer, Marblehead, MA (US); Joseph Flaherty, Westford, MA (US); Timothy Golnik, Boxford, MA (US)

Correspondence Address: Marina Larson & Associates, LLC, P.O. BOX 4928, DILLON, CO, 80435, US

(73) Assignee: AgaMatrix, Inc., Salem, NH (US)

(21) Appl. No.: 11/276,309

(22) Filed: Feb. 23, 2006

(51) Int. Cl. B01L 3/00

(52) U.S. Cl. 422/102

(57) ABSTRACT

A test strip vial has a container, a test strip magazine disposed within the container, and a lid. The magazine has a plurality of test strip slots radially disposed about an axis of the magazine and extending through the first end of the magazine. The lid is rotatably attached about the open end of the container and has a test strip aperture defined therein that is sequentially aligned with each of the test strip slots as the lid is rotated. The vial also has an incremental rotation mechanism associated therewith that permits incremental rotation of the lid relative to the magazine to sequentially align the aperture with each of the slots. Test strips are individually disposed within the slots.

### BACKGROUND

Test strips for medical diagnostic purposes are typically supplied and carried in vials from which they are removed as required by a user, for example, when a diagnostic test is to be carried out. Typical types of test strips include those used for measuring the concentration of an analyte, such as glucose, in a human fluid, such as blood. Test strip vials should be user-friendly and inexpensive to make.

### SUMMARY OF INVENTION

The present invention provides a user-friendly test strip vial that has a container, a test strip magazine, and a lid. The magazine has a plurality of test strip slots radially disposed about an axis of the magazine that extends along the magazine through its first end. The lid is rotatably attached about the open end of the container and has a test strip aperture defined therein that is sequentially aligned with each of the test strip slots as the lid is rotated. The vial also has an incremental rotation mechanism associated therewith that permits incremental rotation of the lid relative to the magazine to sequentially align the aperture with each of the slots. Test strips are individually disposed within the slots.

### BRIEF DESCRIPTION OF THE DRAWING

FIG. 1 is an isometric view of a test strip vial in accordance with the present invention.

FIG. 2 is an isometric view of a test strip magazine in accordance with the present invention.

FIG. 3 is an isometric view of the bottom of a lid for a test strip vial in accordance with the present invention.

FIG. 4 is a side view of an aperture cover in accordance with the present invention.

FIG. 5A is a bottom view of a lid in accordance with the present invention.

FIG. 5B is a top view of a container in accordance with the present invention.

FIG. 6A is a top view of a container or magazine in accordance with the present invention.

FIG. 6B is a bottom view of a lid in accordance with the present invention.

FIG. 6C is a side view of a test strip vial with a separate used test strip storage container in accordance with the present invention.

FIG. 7A is a side view of a test strip vial in accordance with the present invention.

FIG. 7B is an exploded view of a container and magazine in accordance with the present invention.

FIG. 7C is a top view of a test strip magazine in accordance with the present present invention.

FIG. 8 is a bottom view of a magazine having a perforated base cover in accordance with the present invention.

FIG. 9A is a top view of a lid in accordance with the present invention.

FIG. 9B is a top view of a magazine in accordance with the present invention.

FIG. 10 is a top view of a vial in accordance with the present invention.

FIG. 11 is a side view of a vial in accordance with the present invention.

### DETAILED DESCRIPTION OF THE INVENTION

It is often an advantage in the analyte detection industry to provide vials and test strips that are as small as possible to allow a user to carry them with the utmost ease. However, a user of such items may be arthritic or have some other physical impairment which would hinder their ability to remove a single diagnostic test strip from a small vial. This physically-impaired user may find it easier to dump the strips contained in the vial into their hand or onto another potentially contaminated surface in order to retrieve a single test strip for performing a diagnostic test. Subsequently, the user may return potentially contaminated strips to the vial for storage and for future tests.

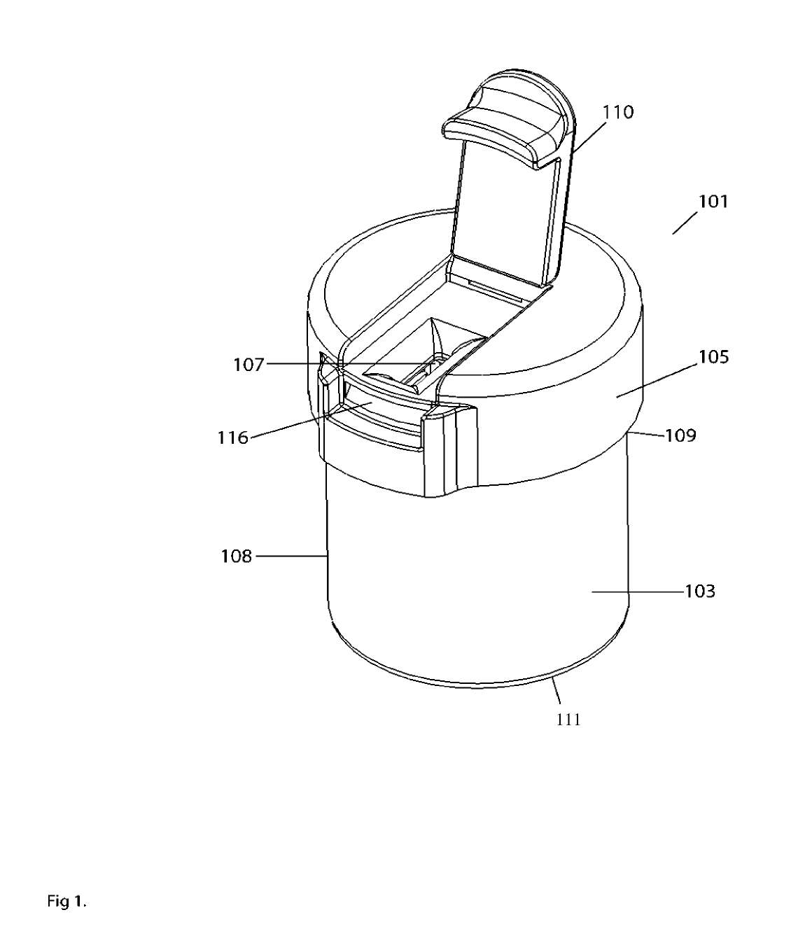

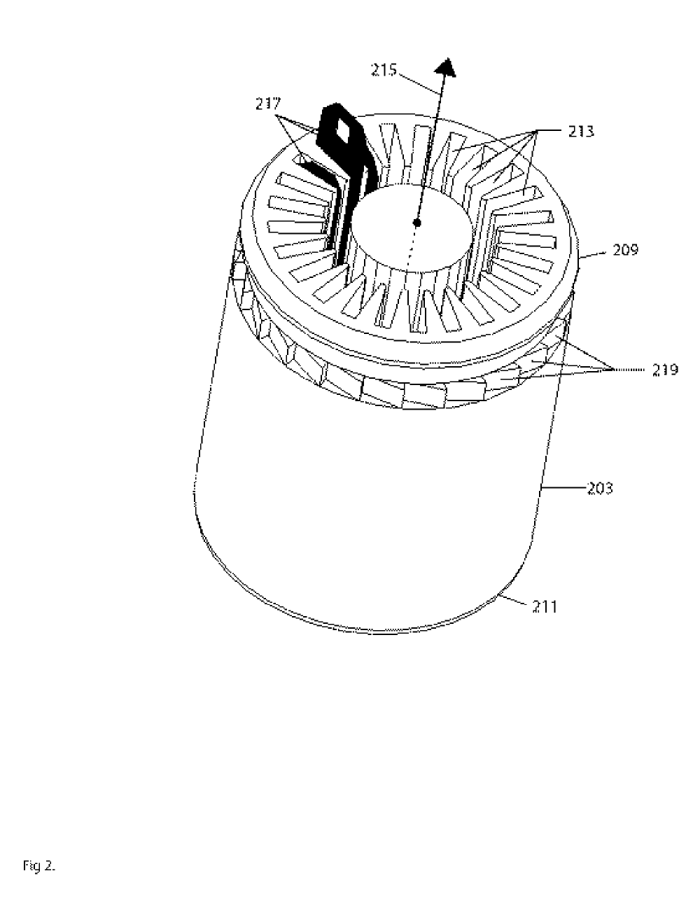

The present invention provides a user-friendly medical diagnostic test strip vial that allows a user to easily retrieve a single test strip from the vial. As depicted in FIG. 1 and in accordance with an embodiment of the present invention, a test strip vial 101 for storing and dispensing test strips comprises a container 103, a test strip magazine (shown in FIG. 2), and a lid 105 rotatably attached about the open end 109 of the container 103. The lid 105 has an aperture 107 defined therein that is sized to allow passage of a test strip. The container 103 has a container space defined by wall 108 that terminates at the open end 109 and at an opposing closed end 111. The container 103 is sized to receive a test strip magazine in the container space. The magazine may either be integral with, attached to, or removable from the container 103.

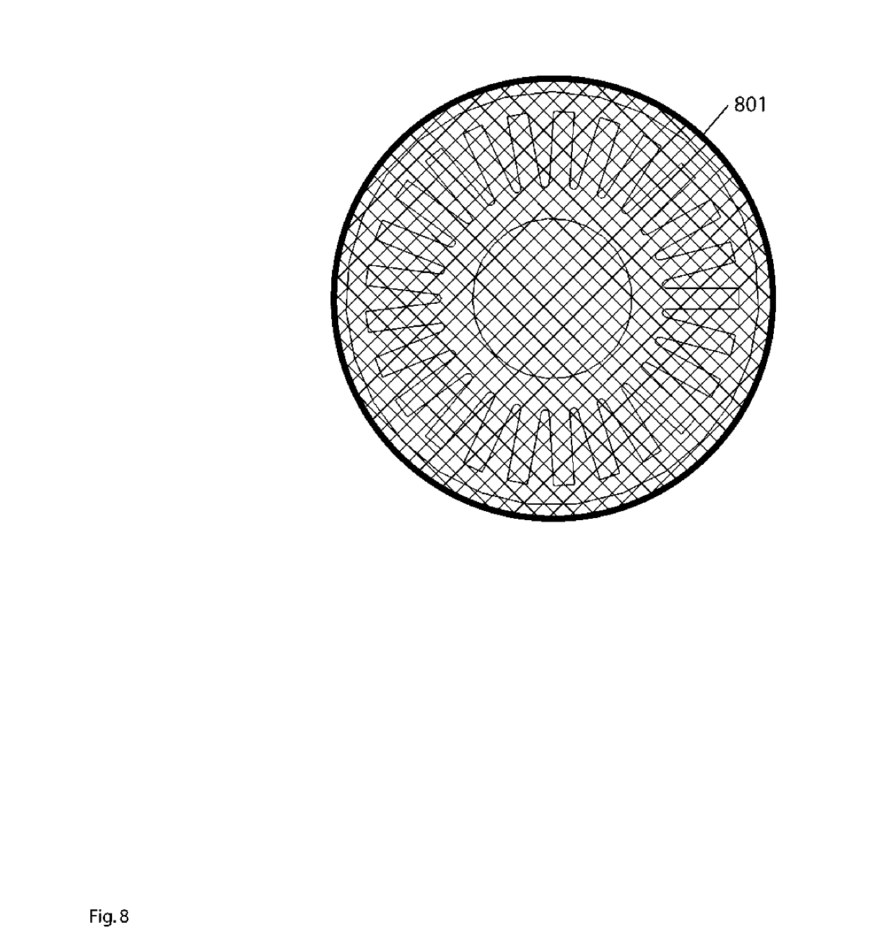

Magazine 203, as shown in FIG. 2, has a first end 209 and an opposing second end 211. Magazine 203 is to be disposed in the container space of the container 103, shown in FIG. 1, such that a first end 209 is closer to the open end 109 of the container 103 and a second end 211 of the magazine 203 is closer to the closed end 111 of the container 103. When the magazine 203 is integral with the container they are one and the closed end 211 of the magazine 203 corresponds to the closed end 111 of the container. Magazine 203 has a plurality of slots 213 extending between the first and the second ends (209, 211) and through the first end 209. Preferably the slots 213 do not extend entirely through the second end 211 of the magazine 203 to prevent the test strips from unduly falling out of the magazine. However, the slots 213 may extend at least partially, if not entirely, through the second end 211 of the magazine 203 provided that the test strips 217 are restrained from falling out of the magazine 203, for example, by a perforated base cover 801 shown in FIG. 8. The plurality of slots 213 are arranged radially about a slot axis 215, wherein each slot 213 is sized to receive an analytical test strip 217 through the first end 209 of the magazine 203. In FIG. 2, magazine 203 also has a plurality of test strips 217 disposed within the plurality of slots 213. Test strips 217 are held in slots 213 of container 203 by the force of gravity (e.g. when the magazine 203 is inverted, test strips 217 fall freely from the slots 213).

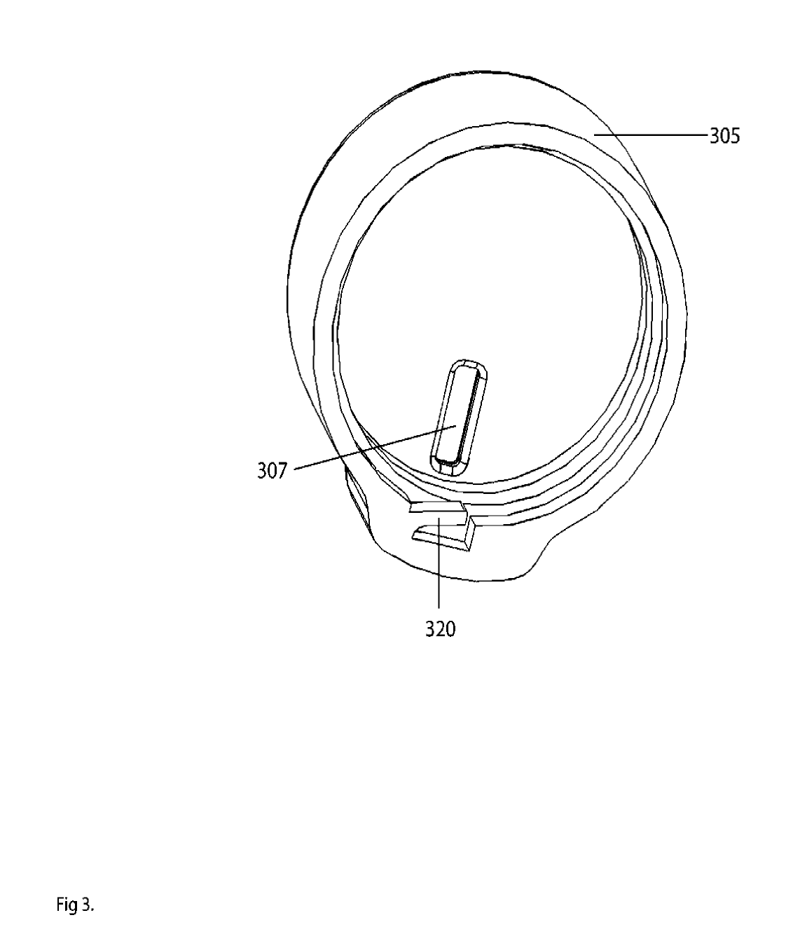

In accordance with an embodiment of the present invention, an incremental rotation mechanism is associated with the container, the magazine, the lid, or any combination thereof for permitting incremental rotation of the lid relative to the magazine in a single direction and to sequentially align the aperture of the lid with each of the slots of the magazine. In a preferred embodiment, this mechanism comprises a first plurality of teeth peripherally disposed on one of (i) an inner side of the lid, (ii) an outer side of the container, or (iii) an outer side of the test strip magazine, and an opposing tooth placed, in interacting alignment with the first plurality of teeth, on one of the other of (i) the inner side of the lid, (ii) the outer side of the container, or (iii) the outer side of the test strip magazine. The opposing tooth is arranged in an opposing direction to the plurality of teeth to allow incremental rotation of the lid respective to the magazine in a single direction so that the aperture is placed into alignment with each of the plurality of slots. As illustrated in FIGS. 2 and 3, a preferred mechanism is a first plurality of teeth 219 disposed on the outer side of the magazine 203 (see FIG. 2) and an opposing tooth 320 disposed on the inner side of the lid 305 (see FIG. 3). Tooth 320 is arranged in an opposing direction to the plurality of teeth 219 to allow rotation of the lid 305 respective to the magazine 203 in one direction and so that the lid aperture 307 is placed into alignment with one of the plurality of slots 213. The aperture 307 of lid 305 is sized to allow passage of a test strip and is sequentially aligned with each of the slots 213 as the lid 305 is rotated relative to the magazine 203. When a user incrementally rotates the lid 305 respective to the magazine 203, thereby aligning the aperture 307 with a slot 213, the user may then retrieve a single test strip 217 by inverting the vial so that a test strip 217 may fall from its slot 217 through the aperture 207. The incremental rotation mechanism is not particularly limited provided that when a user rotates the lid respective to the magazine, the aperture is placed into sequential alignment with each of the plurality of slots. For example, in another embodiment the incremental rotation mechanism comprises a series of depressions disposed on the top of the magazine that interact with a series of protrusions disposed on the underside of the lid to sequentially align the aperture with each test strip slot.

In a preferred embodiment, as the user rotates the lid respective to the magazine a clicking noise will be made to alert the user that the aperture is aligned with a slot and that a test strip, if present in the slot, may be removed from the vial. For example a clicking noise may be made by the interaction of the depression and protrusion embodiment of the incremental rotation mechanism.

As shown in FIG. 1, in a preferred embodiment of the vial 101, the lid 105 further comprises an aperture cover 110. The aperture cover 110 serves to cover the aperture 107 and to protect the test strips contained in the vial 101 from foreign contaminants in the outside atmosphere. The cover 110, when in a closed position, also serves to prevent test strips from unduly falling out of the vial 101 when the vial is inverted.

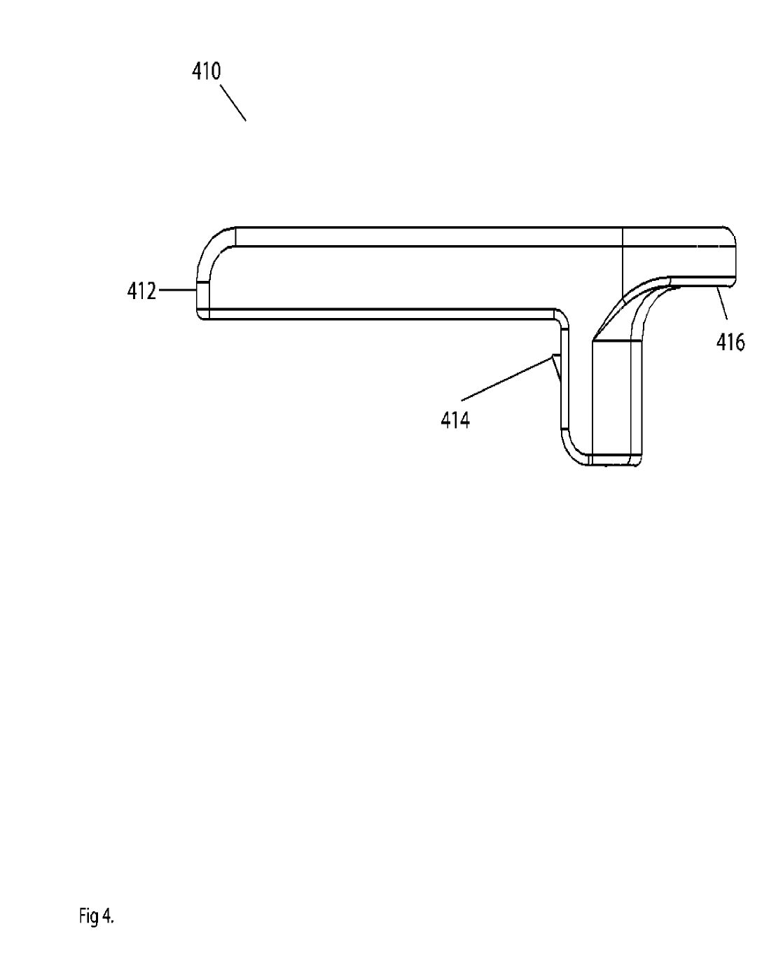

FIG. 4 shows a side view of a preferred aperture cover 410. Cover 410 is designed to be pivotally connected to the lid at end 412. When the cover 410 is in a closed position, tooth 414 snaps into tooth depression 116 shown in FIG. 1. Cover 414 also has a thumb lip to facilitate the ease of opening the vial (i.e. placing the cover into an open position, as depicted in FIG. 1, from a closed position).

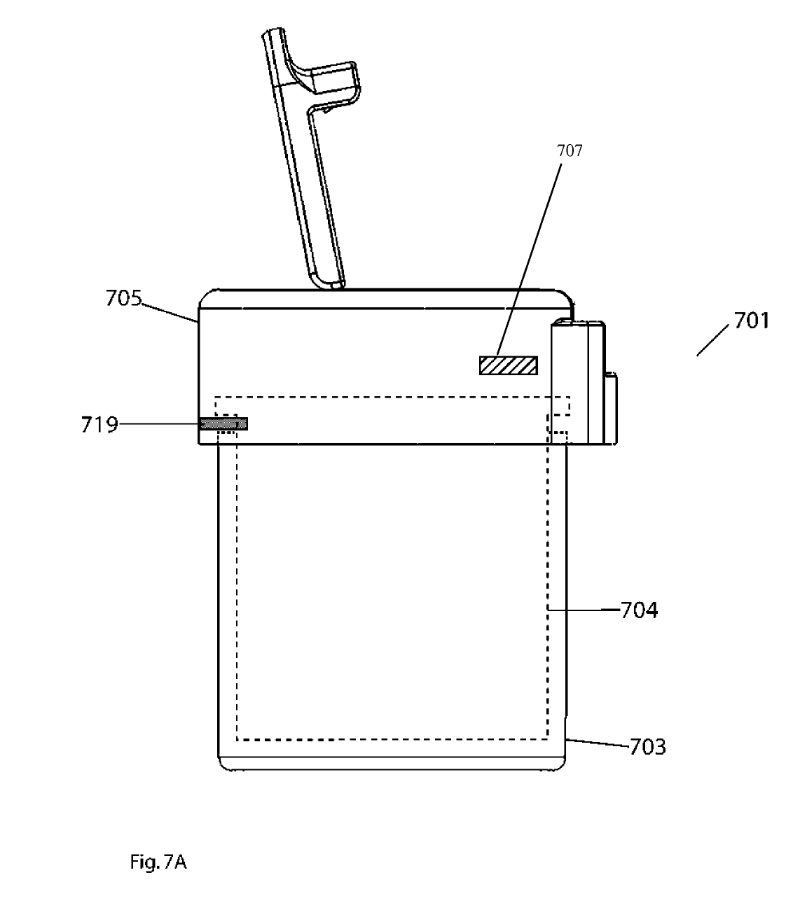

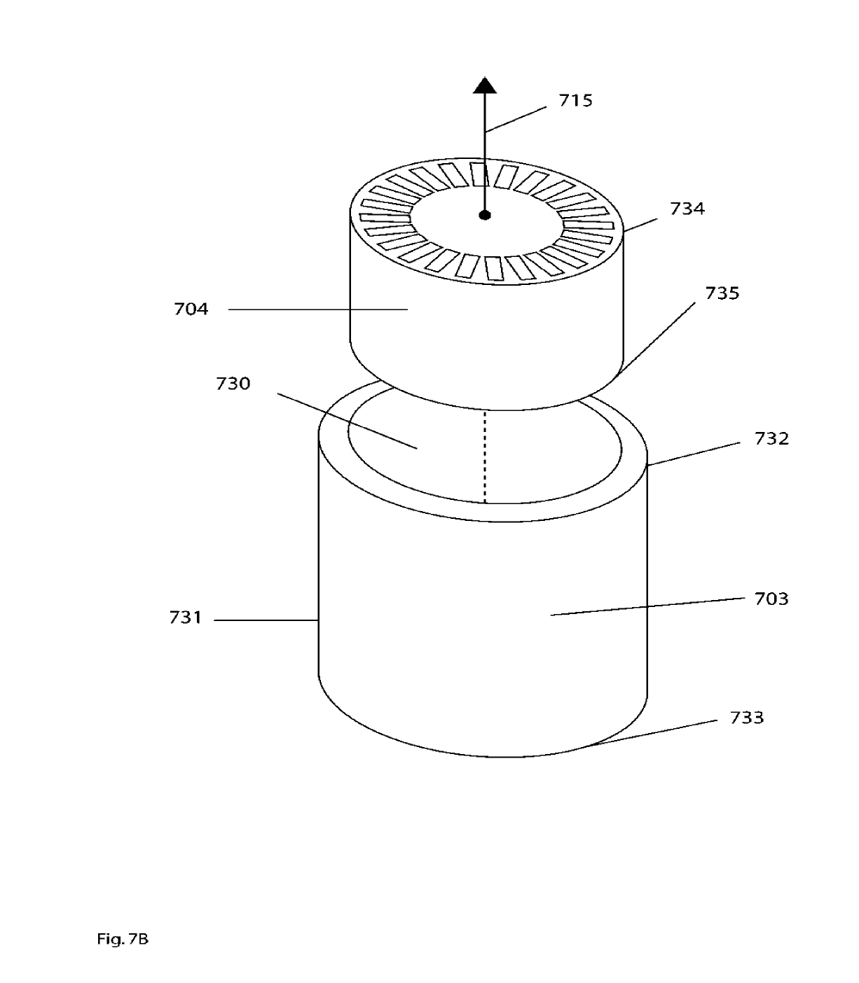

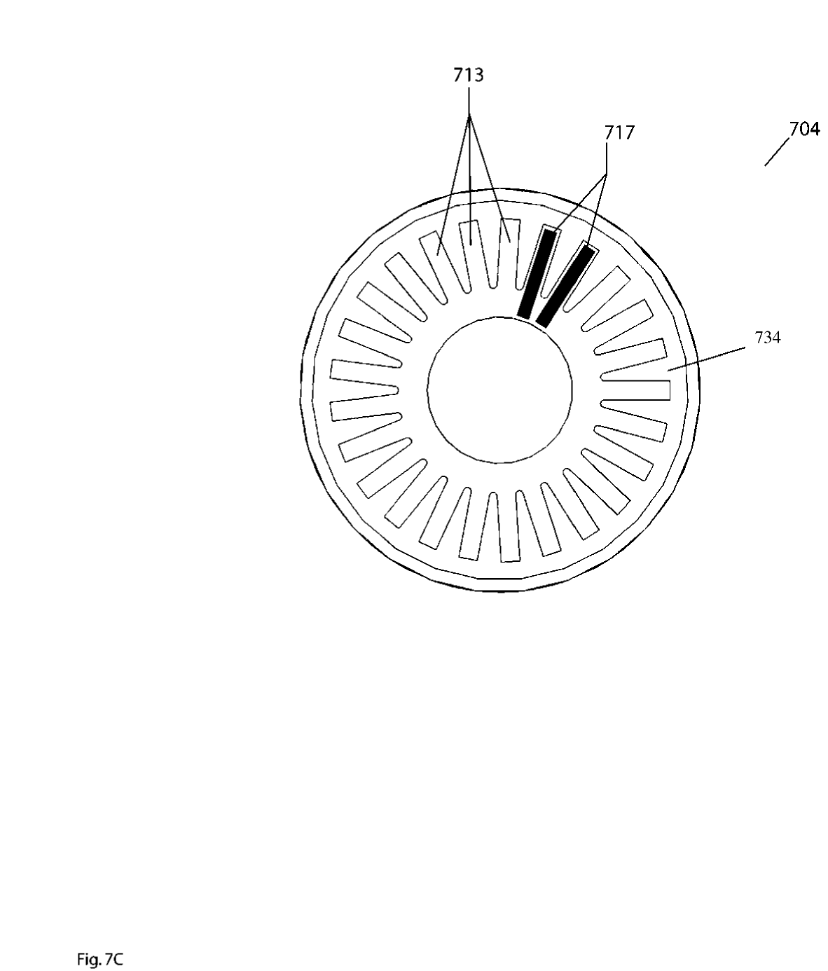

The test strip magazine may either be integral with the container, affixed to the container, or removable from the container. For example, in another embodiment of the present invention, a replaceable magazine may be introduced to and removed from a reusable container and lid assembly. It is contemplated that such a reusable container and lid assembly may be personalized in that a user can design and decorate the reusable assembly, while being able to replace a used test strip magazine with a new magazine containing new and unused test strips. FIG. 7A shows a test strip vial 701 comprising a container 703, a removable and replaceable test strip magazine 704, a lid 705, and an incremental rotation mechanism 719. As illustrated in FIG. 7B, the container 703 has a container space 730 defined by a wall 731 terminating at an open end 732 and at an opposing closed end 733 of the container 703. The container is sized to slidably receive a replaceable test strip magazine 704 in the container space 730. FIG. 7C shows a replaceable test strip magazine 704 having the same general shape as the wall 731 of container 703. Magazine 704 is sized to slidably fit in the container space 730 such that a first end 734 of the magazine 704 is closer to the open end 732 of the container 703 and a second end 735 of the magazine 704 is closer to the closed end 733 of the container 703. As depicted in FIG. 7C, the magazine 704 has a plurality of slots 713 extending through the first end 734 of the magazine 704, each of the slots 713 sized to receive a test strip 717 through the first end 734 extending along the magazine 704 toward the second end 735. The plurality of slots 713 arranged radially about a slot axis 715 of the magazine 704. A lid 705 is rotatably attached to the open end 732 of the container 703. The lid has an aperture 707 defined therein that is sized to allow passage of a test strip 717 and is sequentially aligned with each of the slots 713 of the magazine 704 as the lid 705 is rotated relative to the magazine 704. An incremental rotation mechanism 719 is associated with: the container 703 and the lid 705; the magazine 704 and the lid 705; or the magazine 704, the container 703, and the lid 705. The mechanism 719 permits incremental rotation of the lid 705 relative to the magazine 704 to sequentially align the aperture 707 with each of the plurality of slots 713 of the magazine 704. A preferred incremental rotation mechanism is the opposing tooth configuration discussed above. A plurality of test strips 717 are individually disposed within a plurality of slots 713.

The term “slidably engage” as it is used herein to refer to the sizing of the magazine and container space is understood to mean that the magazine fits into the container. Preferably the fit between the magazine and the container is loose enough to allow a user to slide the magazine into and out of the container with minimal force (e.g. the force applied by one hand of a user) yet tight enough to not allow the magazine to slip within the container as the lid is incrementally rotated with respect to the magazine.

It is often preferred that test strips for medical diagnostic purposes be stored in an environment where there is a reduced moisture content as compared to the normal atmosphere. To maintain this reduced moisture environment it is often desired that the space within the container is sealed from the outside atmosphere using a seal that seals the lid to the container. In addition to sealing the container from the surrounding environment a desiccant may be employed. Non-limiting examples of suitable desiccants include silica gel and molecular sieve material produced by CSP Technologies, Inc. The desiccant may be located in the container, the lid, the magazine or in any combination thereof such that it is in operative contact with the environment of the test strip slots of the magazine to remove moisture therefrom.

In a preferred embodiment the vials of the present invention will be made of a material that allows a user to visually determine how many test strips are disposed within the vial. For example, the lid, the container, or both the lid and the container are preferably made of a transparent material, such as a thermoplastic resin (e.g. polycarbonate).

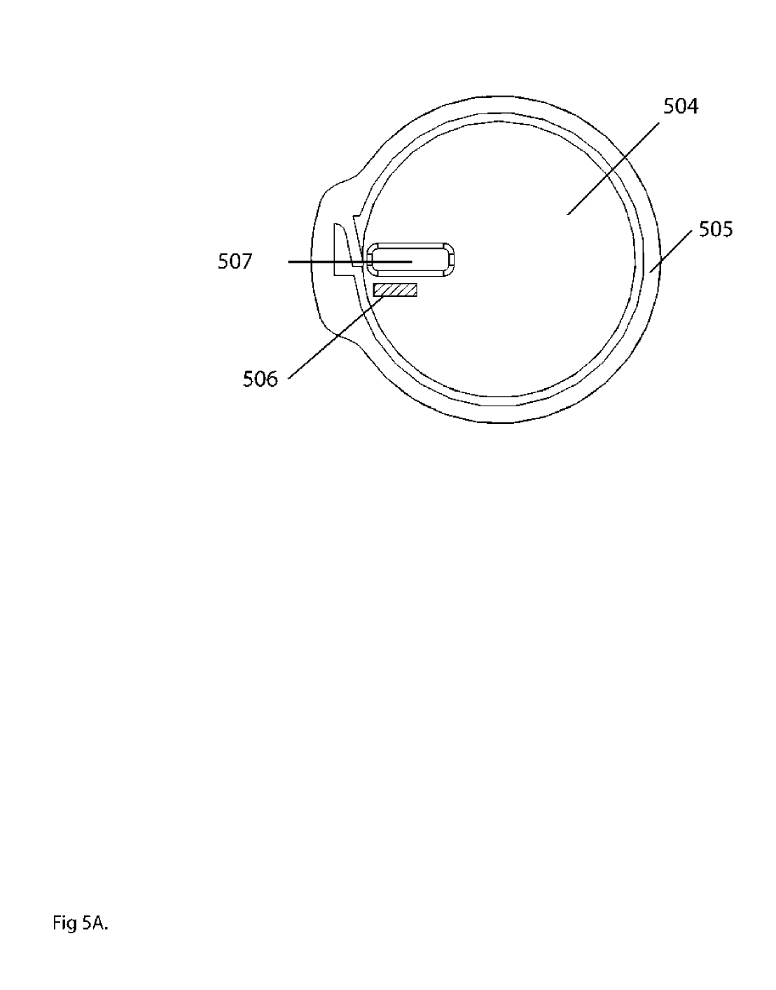

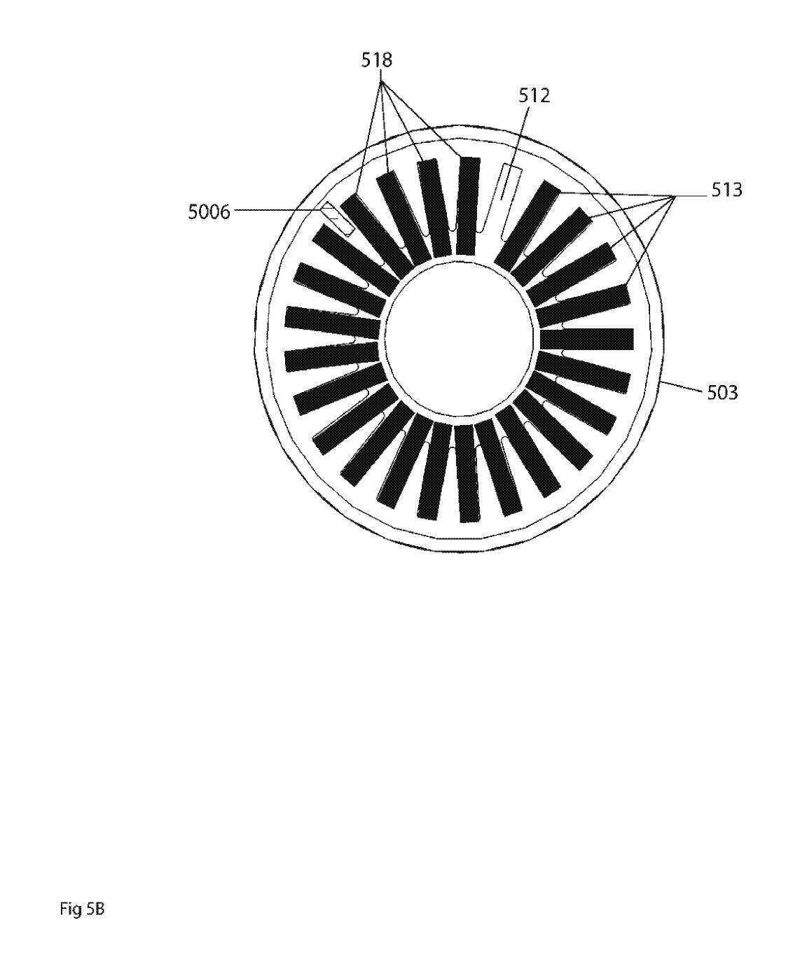

In yet another embodiment of the present invention the vial may also be used for the sanitary storage of used test strips. In one such exemplary embodiment, the vial further comprises a stopping mechanism, or mechanisms, present on the lid, the container, the magazine, or on any combination thereof to prevent the lid from rotating more than 1 complete turn (i.e. more than 360 degrees). In this embodiment, and as shown in FIGS. 5A and 5B, after a user removes a new and unused test strip from a slot 512 and performs a diagnostic test using the strip, the user may subsequently return the used test strip to the slot 512 and rotate the lid 505 respective to the magazine 503 such that the used test strip is safely and sanitarily stored in the vial. The used magazine 503 containing the used test strips 518 may be then be properly disposed of (e.g. by placing the entire vial or the replaceable magazine in a bio hazard disposal bin).

It is preferred that once a user has placed a used test strip 518 in the vial and has incrementally rotated the lid 505 so that the aperture 507 is aligned with the another slot, the used test strip 518 and its associated slot may not again be accessed. As shown in FIG. 5A, the bottom 504 of lid 505 has a stopping mechanism. Here, the stopping mechanism is a protrusion 506 extending outwardly from the bottom side 504 of lid 505. Protrusion 506 is positioned next to aperture 507 and interacts with protrusion 5006 on magazine 503 (shown in FIG. 5B) to prevent the lid 505 from rotating more than one complete turn respective to the magazine 503. The stopping mechanism is not particularly limited. For example the stopping mechanism be a spring load piston extending outwardly from the top of the magazine that interacts with a corresponding depression or hole in the lid to stop the lid from rotating more than one complete turn when the piston is disposed in the depression or hole.

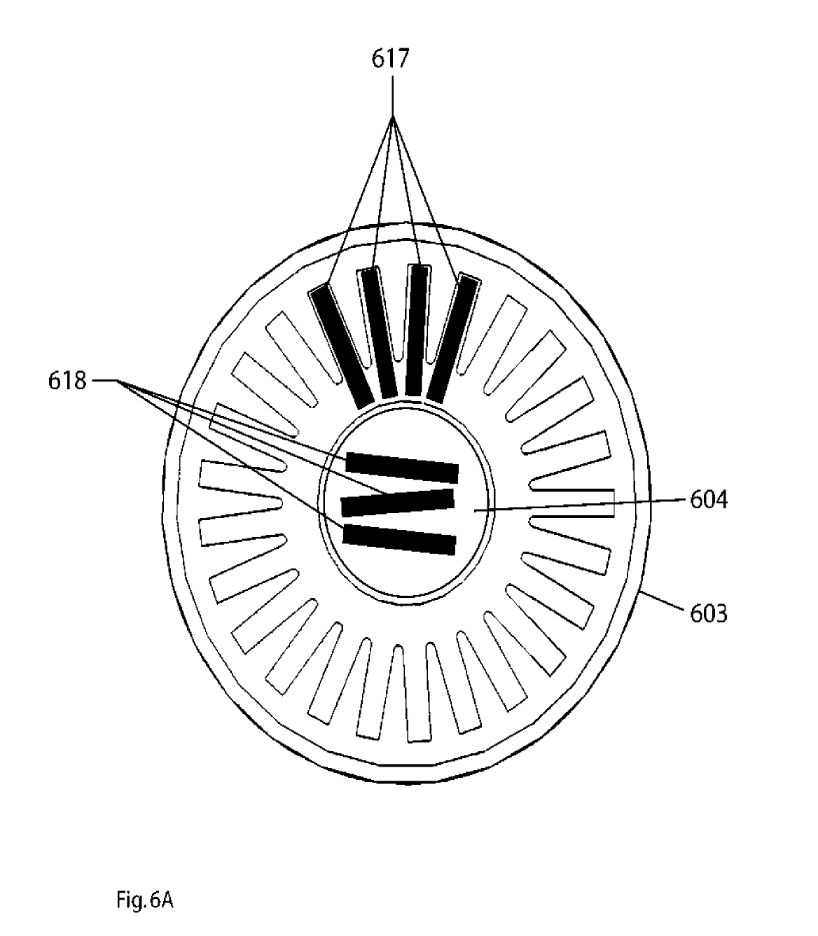

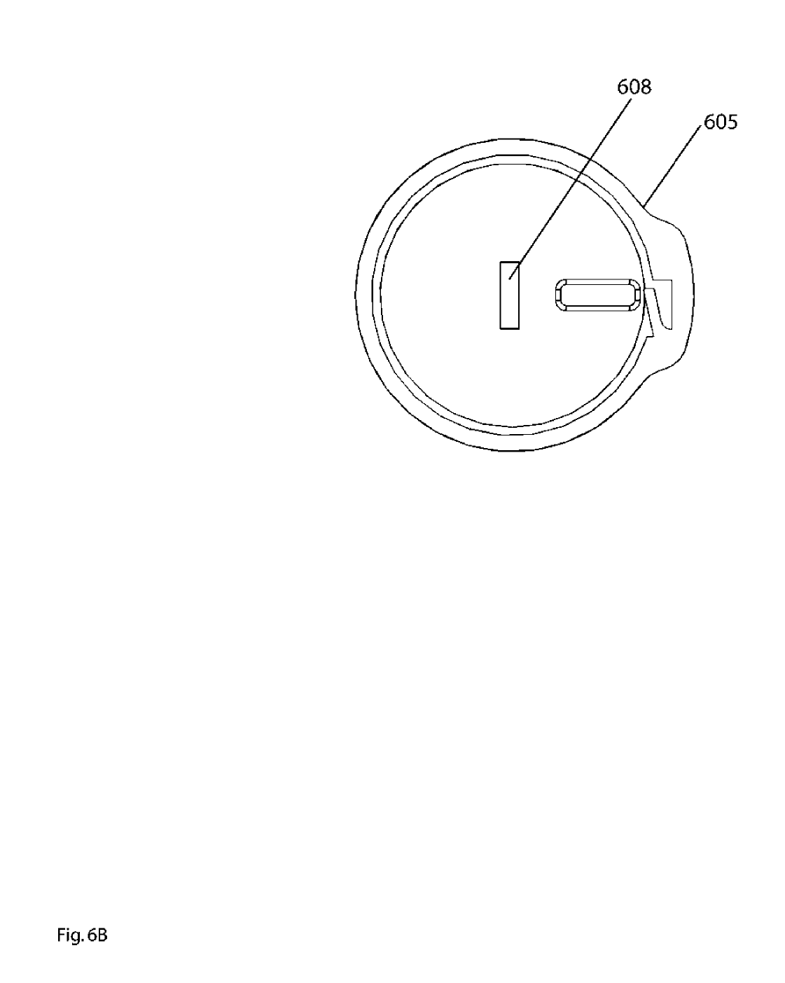

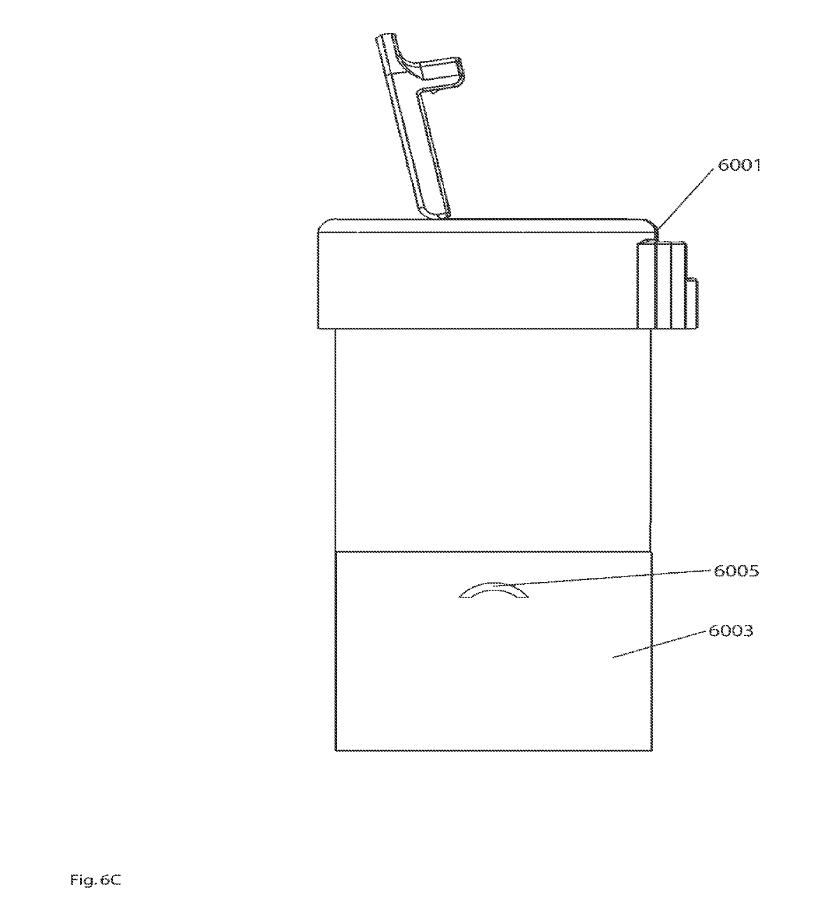

In yet another exemplary embodiment of the present invention where the vial may be used for the sanitary disposal of used test strips, and as depicted in FIGS. 6A and 6B, the magazine 603 further comprises a used test strip chamber 604 extending along the slot axis and through the first end of the magazine 603. The chamber 604 is sized to receive a plurality of used test strips 618. In the present embodiment, lid 605 (shown in FIG. 6B) further comprises a second aperture 608, sized to allow passage of a test strip, that is aligned with the used test strip chamber 604. Chamber 604 provides a storage area for used test strips 618 that is separate from the unused test strips 617, that allows a user to store used test strips 618 until such a time that proper disposal can be accomplished. Preferably the aperture 608 is sized to slidably receive a test strip there through. For example, once a user slides a test strip 618 through aperture 608 into chamber 604 of the magazine 603, the test strip 618 is not able to freely fall from the chamber 604 and out of the vial.

In still a further exemplary embodiment of the present invention where the vials or combinations of the present invention may also be used for the sanitary disposal of used test strips, a separate used test strip container of the type described in U.S. provisional patent application No. 60/743,348, which is herein incorporated by reference, may be detachable from or integral with the lid or the container of the vial of the present invention. In the present embodiment and as depicted in FIGS. 6C, a separate container 6003 is provided having a wall, or walls, defining a used test strip space that is sized to receive a plurality of used test strips. Used test strips are introduced to the space through an opening 6005 in a wall. The shape of the opening 6005 and/or the placement of the opening 6005 about a wall of the container 6003 is selected such that after a test strip is received into the container space it is restrained from freely falling out of the space without covering the opening 6005 with cover or lid. Here the used test strip opening is a curved opening 6005 disposed about a wall of the container 6003. The separate container 6003 may be formed integral with the vial 6001 of the present invention, or it may be detachable therefrom.

The test strips disposed in the slots of the container or magazine of the present invention are not particularly limited. As a non-limiting example, test strips that are suitable for use with the embodiments of the present invention are disclosed in U.S. Pat. No. 10/908,656, which is herein incorporated by reference. Numerous test strips are also commercially sold. For example, test strips sold under the Accu-Check, One Touch Ultra, and Freestyle trademarks are suitable for use with the vials and assemblies of the present invention.

In an embodiment where the container and lid assembly is not reusable and where the test strip magazine is integral with the container, it is preferred that the lid be rotatably attached about the container such that it may not be easily removed therefrom by a user. In an embodiment where a user may replace the test strip magazine while reusing the container and lid assembly, it is preferred that the lid be attached to the container such that a user may remove and replace it for the purpose of easily replacing a used magazine with a new one. For example, the lid may screw onto the container, the lid may snap-fit onto the container, or the lid may snap-fit onto the container as well as be hinged to the container such that when the container is open the lid may be bent back away from the open end of the container.

The number of diagnostic test strips contained in the vial and the number of slots of the magazine of the present invention are not particularly limited. However, logical integers of the same are herein contemplated. For example, the number of tests performed by a user may vary depending on the type of analyte that a user desires to measure within a sample. If a user tests for the concentration of glucose within a blood sample, the number of tests will vary depending on the needs of individual users. This will depend on, inter alia, recommendations from their Doctors and on insurance coverage. For example a user may test the concentration of glucose within their blood once a day. In such a case, a preferred magazine will have test strips disposed in the magazine in multiples of 7, for example 7, 14, 21, or 28. This allows a once-a-day tester to carry a predetermined number of test strips with them that will last in weekly multiples. If the number of test strips disposed in the magazine is 21 it would provide a three-time-a-day tester to carry a week's worth of test strips. Alternatively, insurance companies may allow for different allotments of test strips for individual diabetic users. For example an insurance company may allow for allotments of 25 or 50 strips to users per month for an individual user. In such a case the vial of the present invention will contain the number of test strips allowable for an individual user for, inter alia, a day, a week, or a month.

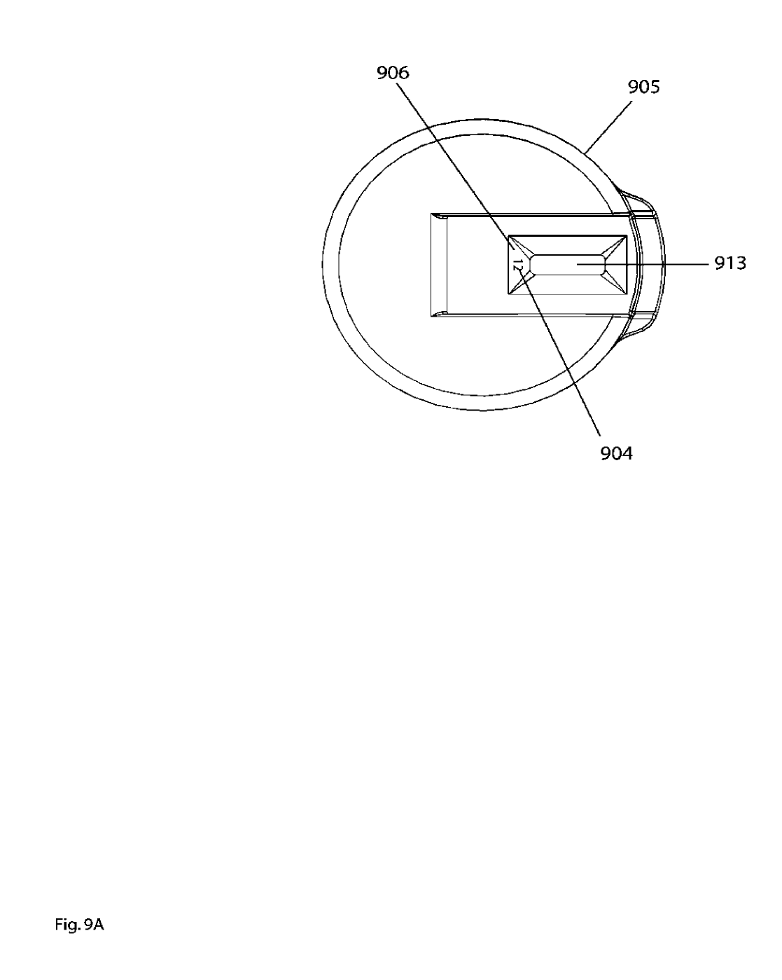

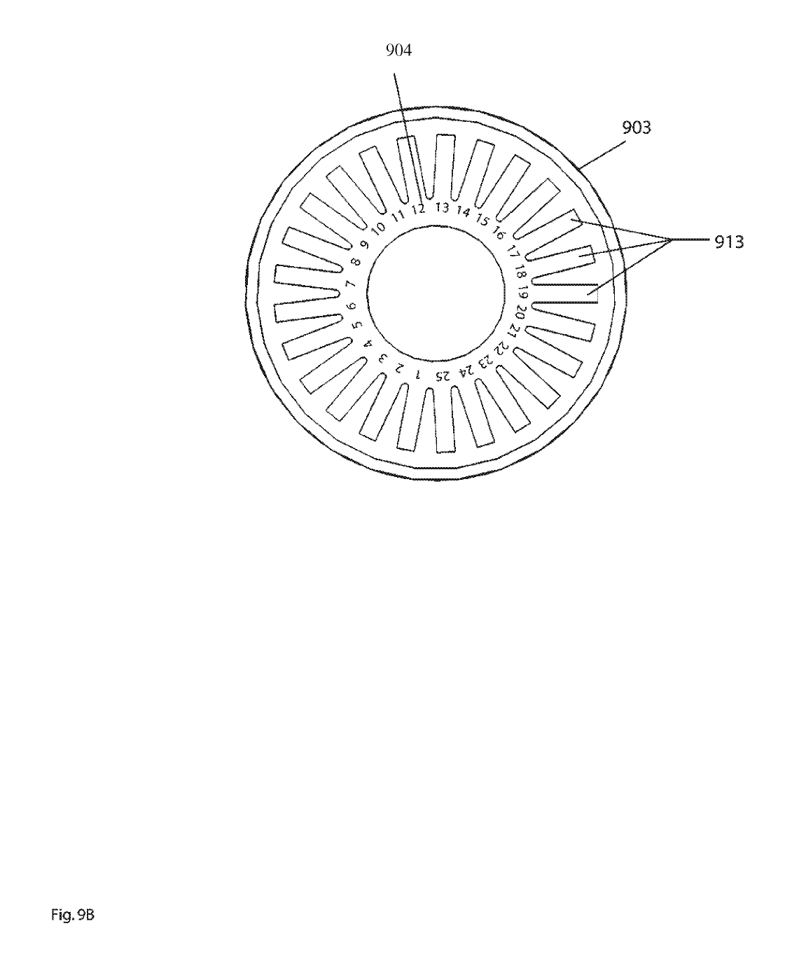

In another embodiment the container, the lid, the magazine, or any combination thereof comprises means for allowing a user to determine if a particular diagnostic test strip has been removed from the vial thereby indicating whether a particular diagnostic test has been performed. The means for allowing a user to determine whether a particular test has been performed is not particularly limited. For example, in one embodiment, a marker is disposed on the container, the lid, the magazine, or on any combination thereof. The marker correlates an individual test strip slot with a particular test. In one embodiment, a portion of the container or the lid comprises a material that permits visualization of the individual test strip slot. The material is preferably a transparent thermoplastic resin. If a particular test strip slot appears empty, or contains a used test strip, a user can conclude that the correlating test has already been performed. For example a once-a-day tester can conclude that the test for that day has been performed and that no further test is required for the day. As shown in FIGS. 9A and 9B, and in accordance with the present embodiment, magazine 903 has markings 904 disposed on its first end (here numbers 1 through 25). The lid 905 has a window 906 made from a transparent material that allows a user to visualize the markings 904 on the magazine while viewing the test strip slot through the aperture.

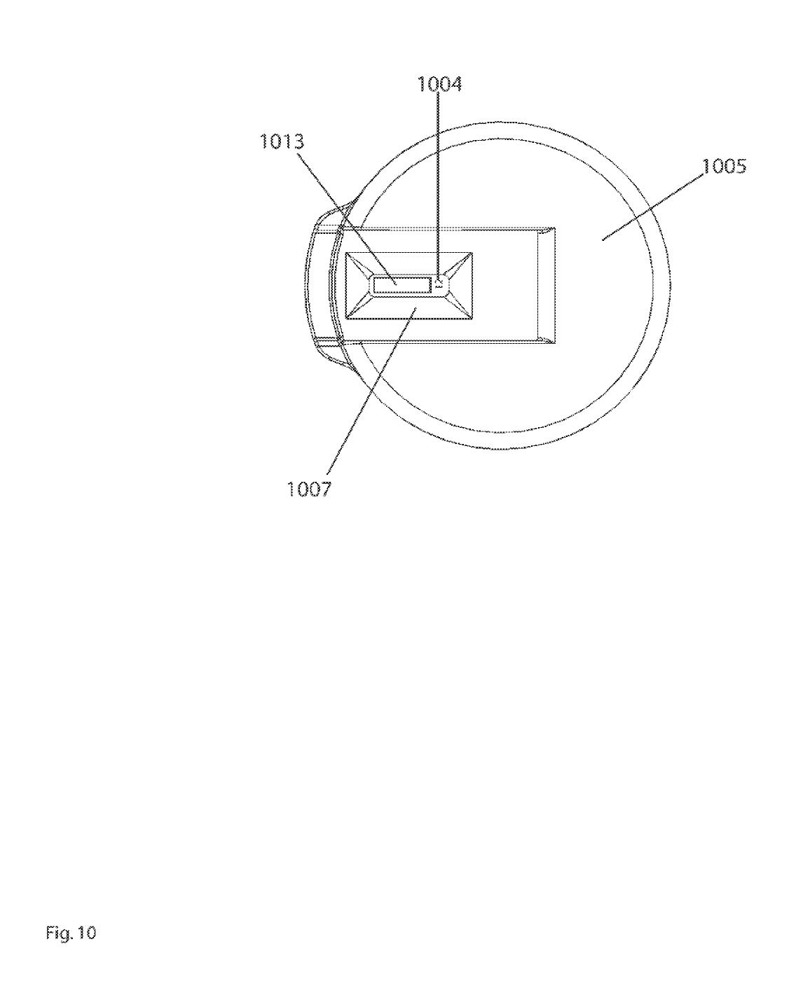

In another embodiment shown in FIG. 10, a marking 1004 appears above or below the test strip slot 1013 on the magazine. A user may view both the marking 1004 and the test strip slot 1013 through the aperture 1007 of the lid 1005.

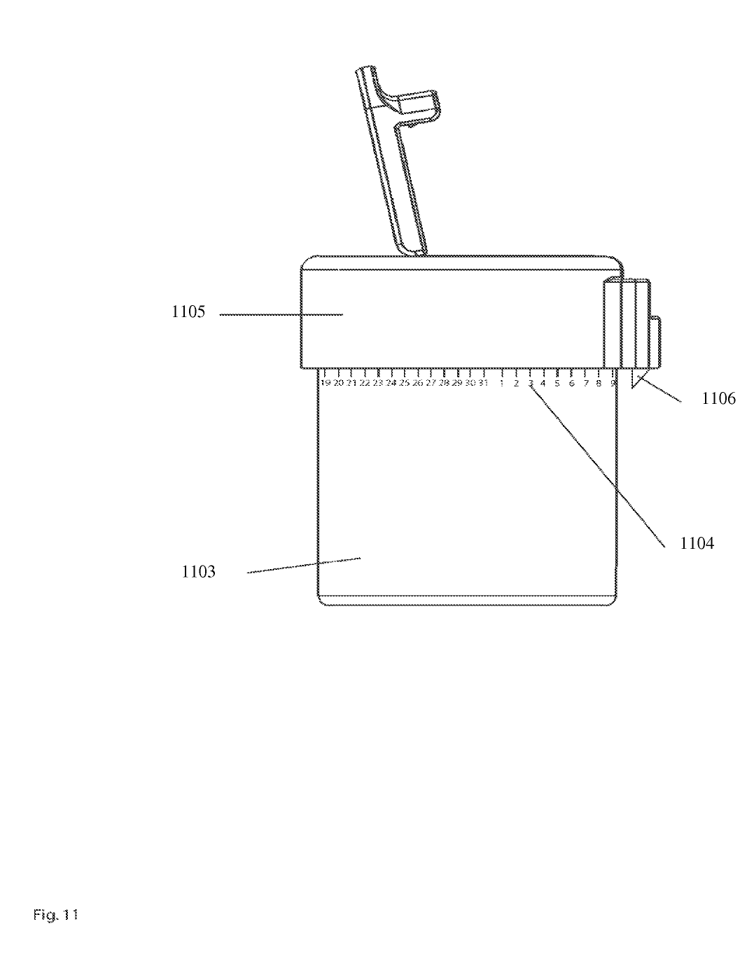

In another embodiment as shown in FIG. 11, the means for allowing a user to determine whether a particular test has been performed comprises a series of markings 1104 disposed about the periphery of the container 1103 that correlate the individual test strip slots with specific tests and a corresponding arrow 1106 disposed on the periphery of the lid 1105 that points to an individual marking 1104 when the aperture is aligned with an individual slot. The user may then look through the aperture of the lid 1105 to determine if a test strip is present therein. In the alternative a user may invert the vial to determine if a test strip is present. If no test strip is present, a user may conclude that the particular test had been performed.

1. A combination comprising:
(a) a test strip vial comprising:
a container having a container space defined by a wall terminating at an open end and at an opposing closed end of the container, the container sized to receive a test strip magazine in the container space,
a test strip magazine, disposed within the container space such that a first end of the magazine is closer to the open end of the container and a second end of the magazine is closer to the closed end of the container, the magazine having a plurality of slots extending through the first end of the magazine, each of the slots sized to receive a test strip through the first end extending along the magazine toward the second end, the plurality of slots arranged radially about a slot axis of the magazine,
a lid rotatably attached about the open end of the container, the lid having an aperture defined therein, the aperture being sized to allow passage of a test strip and sequentially aligned with each of the slots of the magazine as the lid is rotated relative to the magazine,
an incremental rotation mechanism to permit incremental rotation of the lid relative to the magazine to sequentially align the aperture with each of the plurality of slots of the magazine, and
(b) a plurality of test strips individually disposed within the slots.

2. The combination of claim 1, wherein the magazine is integral with the container.

3. The combination of claim 1, wherein the container is affixed to the magazine.

4. The combination of claim 1, wherein the magazine is removable and is sized to slidably fit into the container space.

5. The combination of claim 1, wherein the incremental rotation mechanism comprises a first plurality of teeth peripherally disposed on one of (i) an inner side of the lid, (ii) an outer side of the container, or (iii) an outer side of the test strip magazine, and an opposing tooth placed, in interacting alignment with the first plurality of teeth, on one of the other of (i) the inner side of the lid, (ii) the outer side of the container, or (iii) the outer side of the test strip magazine, wherein the opposing tooth is arranged in an opposing direction to the plurality of teeth to allow incremental rotation of the lid respective to the magazine in a single direction so that the aperture is in alignment with each of the plurality of slots.

6. The combination of claim 1, wherein the container, the lid, the magazine, or any combination thereof comprises means for allowing a user to determine if a particular test has been performed.

7. The combination of claim 6, wherein the means for allowing a user to determine whether a particular test has been performed comprises:
(a) a marker disposed on the container, the lid, the magazine, or on any combination thereof, the marker correlating an individual test strip slot with a particular test, and
(b) a portion of the container or the lid comprises a material that permits visualization of the individual test strip slot.

8. The combination of claim 1, wherein the lid further comprises an aperture cover pivotally connected to the lid, wherein when the aperture cover is (i) in a closed position, the aperture is covered by the aperture cover, and (ii) in an open position, a test strip, disposed in a slot in incremental alignment with the aperture, may be removed from the vial.

9. The combination of claim 1, wherein the incremental rotation mechanism permits incremental rotation of the lid relative to the magazine in only one direction.

10. The combination of claim 9, further comprising a stopping mechanism that prevents the lid from rotating more than 360 degrees relative to the magazine.

11. The combination of claim 10, wherein the stopping mechanism comprises a protrusion disposed on the inside of the lid and a protrusion disposed on the first end of the magazine.

12. The combination of claim 1, wherein the magazine further comprises a used test strip chamber, sized to receive a plurality of used test strips, extending along the slot axis and through the first end of the magazine and wherein the lid further comprises a second aperture aligned with the used test strip chamber, wherein the second aperture is sized to allow passage of a test strip.

13. The combination of claim 1, further comprising a used diagnostic test strip storage container integral with or detachable from the vial container, the used diagnostic test strip storage container comprising:
(i) a container wall defining an enclosed used strip container space, and
(ii) a test strip opening extending through the container wall connecting the outside environment with the enclosed used strip container space, wherein the test strip opening is sized to receive a test strip,
where the test strip opening (1) is disposed through the container in a position; (2) is shaped; or (3) is disposed through the container in a position and is shaped to restrain a test strip disposed in the used strip container space from falling out of the used strip storage container.

14. A test strip vial comprising:
a container having a container space defined by a wall terminating at an open end and at an opposing closed end of the container, the container sized to receive a test strip magazine in the container space,
a test strip magazine, disposed within the container space such that a first end of the magazine is closer to the open end of the container and a second end of the magazine is closer to the closed end of the container, the magazine having a plurality of slots extending through the first end of the magazine, each of the slots sized to receive a test strip through the first end extending along the magazine toward the second end, the plurality of slots arranged radially about a slot axis of the magazine,
a lid rotatably attached about the open end of the container, the lid having an aperture defined therein, the aperture being sized to allow passage of a test strip and sequentially aligned with each of the slots of the magazine as the lid is rotated relative to the magazine, and
an incremental rotation mechanism associated with to permit incremental rotation of the lid relative to the magazine to sequentially align the aperture with each of the plurality of slots of the magazine.

15. The vial of claim 14, wherein the magazine is integral with the container.

16. The vial of claim 14, wherein the container is affixed to the magazine.

17. The vial of claim 14, wherein the magazine is removable and is sized to slidably fit into the container space.

18. The vial of claim 14, wherein the incremental rotation mechanism comprises a first plurality of teeth peripherally disposed on one of (i) an inner side of the lid, (ii) an outer side of the container, or (iii) an outer side of the test strip magazine, and an opposing tooth placed, in interacting alignment with the first plurality of teeth, on one of the other of (i) the inner side of the lid, (ii) the outer side of the container, or (iii) the outer side of the test strip magazine,, wherein the opposing tooth is arranged in an opposing direction to the plurality of teeth to allow incremental rotation of the lid respective to the magazine in a single direction so that the aperture is in alignment with each of the plurality of slots.

19. The vial of claim 14, wherein the container, the lid, the magazine, or any combination thereof comprises means for allowing a user to determine if a particular test has been performed.

20. The vial of claim 19, wherein the means for allowing a user to determine whether a particular test has been performed comprises:
(a) a marker disposed on the container, the lid, the magazine, or on any combination thereof, the marker correlating an individual test strip slot with a particular test, and
(b) a portion of the container or the lid comprises a material that permits visualization of the individual test strip slot.

21. The vial of claim 14, wherein the lid further comprises an aperture cover pivotally connected to the lid, wherein when the aperture cover is (i) in a closed position, the aperture is covered by the aperture cover, and (ii) in an open position, a test strip, disposed in a slot in incremental alignment with the aperture, may be removed from the vial.

22. The vial of claim 14, wherein the incremental rotation mechanism permits incremental rotation of the lid relative to the container in only one direction.

23. The vial of claim 22, further comprising a stopping mechanism that prevents the lid from rotating more than 360 degrees relative to the container.

24. The vial of claim 23, wherein the stopping mechanism comprises a protrusion disposed on the inside of the lid and a protrusion disposed on the first end of the container.

25. The vial of claim 14, wherein the container further comprises a used test strip chamber, sized to receive a plurality of used test strips, extending along the slot axis and through the first end of the container and wherein the lid further comprises a second aperture aligned with the used test strip chamber, wherein the second aperture is sized to allow passage of a test strip.

26. The vial of claim 14, further comprising a used diagnostic test strip storage container integral with or detachable from the vial container, the used diagnostic test strip storage container comprising:
(i) a container wall defining an enclosed used strip container space, and
(ii) a test strip opening extending through the container wall connecting the outside environment with the enclosed used strip container space, wherein the test strip opening is sized to receive a test strip,
where the test strip opening (1) is disposed through the container in a position; (2) is shaped; or (3) is disposed through the container in a position and is shaped to restrain a test strip disposed in the used strip container space from falling out of the used strip storage container.

27. A disposable test strip magazine comprising:
a generally annular housing having a first end, a second end, and a plurality of slots extending along the magazine toward the second end and through the first end, each of the slots sized to receive a test strip through the first end, the plurality of slots arranged
radially about a slot axis of the magazine,
the magazine further comprising a plurality of test strips individually disposed within the slots,
the magazine for use with a test strip vial comprising:
a container having a container space defined by a wall terminating at an open end and at an opposing closed end of the container, the container sized to receive the test strip magazine in the container space,
a lid rotatably attached about the open end of the container, the lid having an aperture defined therein, the aperture being sized to allow passage of a test strip and sequentially aligned with each of the slots of the magazine as the lid is rotated relative to the magazine, and
an incremental rotation mechanism to permit incremental rotation of the lid relative to the magazine to sequentially align the aperture with each of the plurality of slots of the magazine.

28. The magazine of claim 27, wherein the magazine further comprises a used test strip chamber, sized to receive a plurality of used test strips, extending along the slot axis and through the first end of the magazine and wherein the lid further comprises a second aperture aligned with the used test strip chamber, wherein the second aperture is sized to allow passage of a test strip.
